(19) United States
(12) Patent Application Publication
(10) Pub. No.: US 2010/0215418 A1
(43) Pub. Date: Aug. 26, 2010

(54) RECORDING MEDIUM TRANSPORT DEVICE AND IMAGE FORMING APPARATUS

(75) Inventors: Yasushi Kawahata, Kanagawa (JP); Hidekazu Yamagiwa, Kanagawa (JP); Shuuichi Yamamura, Kanagawa (JP); Masaru Funayanagi, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/556,664

(22) Filed: Sep. 10, 2009

(30) Foreign Application Priority Data
Feb. 25, 2009 (JP) 2009-042106

(51) Int. Cl. G03G 15/00

(52) U.S. Cl. 399/388

(57) ABSTRACT

An aspect of the invention is a recording medium transport device including: a rotating body pair including a pair of rotating bodies disposed on a transport path of a recording medium; a pressing mechanism pressing the rotating bodies in a direction to approach each other; elastically deformable first-large-diameter-portions provided at both axial direction outer-sides of a region where the recording medium passes of at least one of the rotating bodies, the first-large-portions having a larger diameter than the outer diameter at the region; and second-large-diameter-portions provided at both axial direction outer-sides of the region of at least one of the rotating bodies, the second-large-diameter-portions having a larger diameter than the outer diameter at the region and having a smaller diameter than the first-large-diameter-portions, and the second-large-diameter-portions forming a gap between peripheral faces of the rotating bodies at the region in a state where the first-large-diameter-portions are elastically deformed.

### CROSS-REFERENCE TO RELATED APPLICATION

This application claims priority under 35 USC 119 from Japanese Patent Application No. 2009-042106 filed Feb. 25, 2009.

### BACKGROUND

1. Technical Field

The present invention relates to a recording medium transport device and an image forming apparatus.

2. Related Art

Image forming apparatuses are known that form images using ink, toner or the like on a recording sheet. Some such image forming apparatuses are provided with a leveling unit that levels a burr of a cut portion of a recording sheet on the transport path.

### SUMMARY

The recording medium transport device of an aspect of the present invention includes: a rotating body pair that includes a pair of rotating bodies disposed on a transporting path of a recording medium; a pressing mechanism that presses the rotating bodies in a direction such that the rotating bodies approach each other; first large diameter portions that are elastically deformable and are provided at both axial direction outer sides of a region where the recording medium passes of at least one of the rotating bodies, the first large diameter portions having a larger diameter than the outer diameter at the region; and second large diameter portions that are provided at both axial direction outer sides of the region of at least one of the rotating bodies of the rotating body pair, the second large diameter portions having a larger diameter than the outer diameter at the region and having a smaller diameter than the first large diameter portions, and the second large diameter portions forming a gap between peripheral faces of the rotating bodies at the region in a state where the first large diameter portions are elastically deformed.

### BRIEF DESCRIPTION OF THE DRAWINGS

Exemplary embodiments of the present invention will be described in detail based on the following figures, wherein:

FIG. 1 is an overall view schematically showing the internal configuration of a printer according to an exemplary embodiment of the present invention;

FIG. 2A is a side view showing a transport device according to an exemplary embodiment of the present invention and the vicinity thereto;

FIG. 2B is a vertical cross-section along the transporting direction at a width direction central portion of the transport device and the vicinity thereto;

FIG. 3A shows a roll pair of a transport device according to an exemplary embodiment of the present exemplary embodiment, with the roll pair shown in a separated state as seen in a back view from the transporting direction upstream side;

FIG. 3B shows the roll pair in an adjacent state as seen in a back view from the transporting direction upstream side;

FIG. 4 is an overall view corresponding to FIG. 1, schematically showing a transport device according to an exemplary embodiment of the present invention disposed in another exemplary position;

FIGS. 5A to 5C show a roll pair of a transport device according to an exemplary embodiment of the present exemplary embodiment, with the roll pair shown in a back view from the transporting direction upstream side in an operational sequence when a recording paper thicker than a gap is transported;

FIG. 6 is an expanded view of an axial end portion of a second roll of a transport device according to an exemplary embodiment of the present invention;

FIG. 7 is a back view from the transporting direction upstream side of a roll pair of a transport device of a first exemplary modification according to an exemplary embodiment of the present invention;

FIG. 8 is a back view from the transporting direction upstream side of a roll pair of a transport device of a second exemplary modification according to an exemplary embodiment of the present invention;

FIG. 9 is a back view from the transporting direction upstream side of a roll pair of a transport device of a third exemplary modification according to an exemplary embodiment of the present invention;

FIG. 10 is a back view from the transporting direction upstream side of a roll pair of a transport device of a fourth exemplary modification according to an exemplary embodiment of the present invention;

FIG. 11 is a back view from the transporting direction upstream side of a roll pair of a transport device of a fifth exemplary modification according to an exemplary embodiment of the present invention;

FIG. 12 is a back view from the transporting direction upstream side of a roll pair of a transport device of a sixth exemplary modification according to an exemplary embodiment of the present invention; and

FIG. 13 is a back view from the transporting direction upstream side of a roll pair of a transport device of a seventh exemplary modification according to an exemplary embodiment of the present invention.

### DETAILED DESCRIPTION

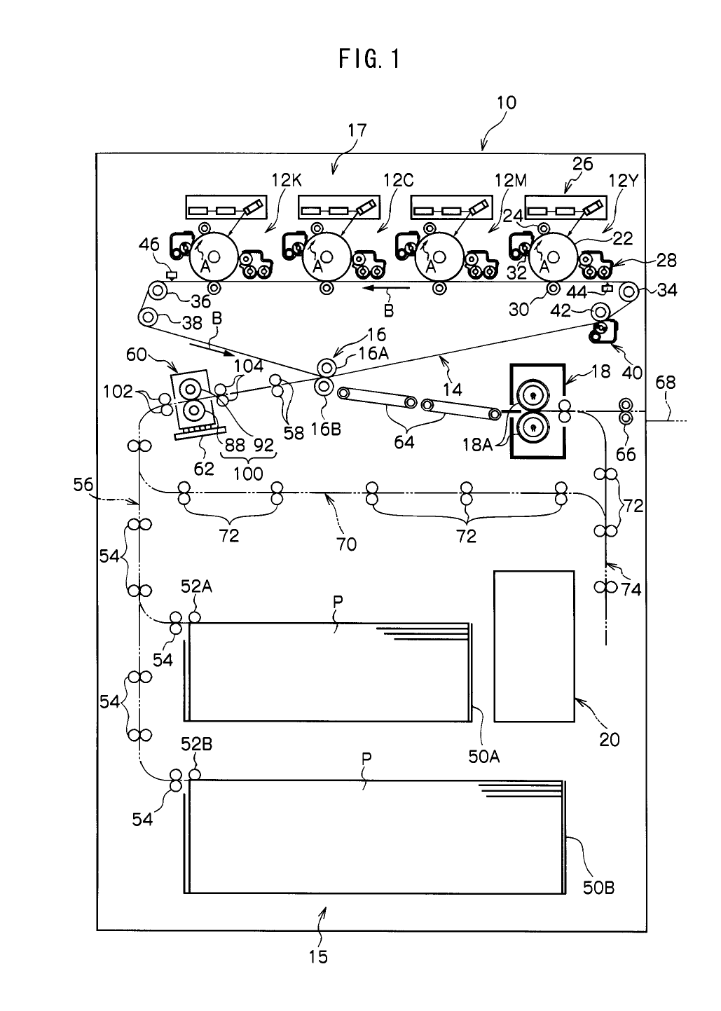

Explanation will now be given of a recording medium transport device and an image forming apparatus according to an exemplary embodiment of the present invention, with reference to FIG. 1. FIG. 1 is an overall view schematically showing the internal structure of a printer, serving as an image forming apparatus according to the exemplary embodiment of the present invention.

As shown in FIG. 1, a printer 10 includes, at the inside thereof, a paper feeding device 15 that houses recording paper (cut sheets of paper) P serving as a recording medium and feeds the recording paper P, and an image forming section 17 that forms a color image on the recording paper P fed from the paper feeding device 15. A transport device 60 that transports the recording paper P and lowers a burr of a cut portion of the recording paper P is provided on a paper transporting path 56 of the paper feeding device 15 and the image forming section 17. A control unit 20 is also provided that controls the operation of the printer 10 as a whole.

Explanation will now be given of the image forming section 17.

The image forming section 17 includes plural image forming units 12 that form toner images with each color component using electrophotographic method. The present exemplary embodiment includes an image forming unit 12Y that forms a yellow (Y color) toner image, an image forming unit 12M that forms a magenta (M color) toner image, an image forming unit 12C that forms a cyan (C color) toner image, and an image forming unit 12K that forms a black (K color) toner image.

When discrimination is made between each of the colors yellow, magenta, cyan, and black the suffixes Y, M, C, and K will be affixed in the explanation, however when there is no need to discriminate between each of the colors the suffixes Y, M, C, and K will be omitted. Also, since the plural image forming units 12Y, 12M, 12C, 12K are configured with similar components except for the toner thereof, reference numbers will be attached to each of the components (members) of the image forming unit 12Y, and the reference numbers of components (members) of the image forming units 12M, 12C, 12K will be omitted.

The image forming section 17 includes: an intermediate transfer belt 14 onto which each of the color component toner images formed at each of the image forming units 12 is sequentially transferred (first-transferred) and held; a second transfer unit 16 that batch-transfers (second-transfers) a color toner image, which is formed by the toner images being transferred onto and superimposed on the intermediate transfer belt 14, onto the recording paper P serving as a recording medium; and a fixing unit 18 that fixes the second-transferred toner image on the recording paper P.

Each of the image forming units 12 includes a circular cylindrical shaped photoreceptor 22 that rotates in the direction of arrow A, with the following disposed in sequence around the photoreceptor 22 in the rotation direction: a charging roll 24 that charges the photoreceptor 22; a laser exposure unit 26 that forms an electrostatic latent image on the photoreceptor 22 by exposure beam; a developing unit 28 that accommodates one of the respective color component toners and makes the latent image on the photoreceptor 22 to a visible image with the toner; a first transfer roll 30 that transfers the toner image of the respective component color formed on the respective photoreceptor 22 onto the intermediate transfer belt 14; and a cleaning unit 32 that removes remaining toner on the photoreceptor 22.

The image forming units 12Y, 12M, 12C, 12K are disposed substantially in a straight line in the sequence yellow (Y color), magenta (M color), cyan (C color), black (K color), from the upstream side in the moving direction of the intermediate transfer belt 14.

The color component toners are charged with a negative polarity in the present exemplary embodiments, and are fine particles formed by internally adding a colorant and a wax to a binder resin, such as polyester or styrene acrylic, using a suspension polymerization method, an emulsion aggregation method, or a solution suspension method. Each of the color component toners Y, M, C, K are not limited to any particular method of manufacture, and various types of toner can be used.

The intermediate transfer belt 14 is formed by including a suitable amount of carbon black or the like in various types of rubber or a resin such as a polyimide, polycarbonate, polyester, polypropylene, polyethylene terephthalate or the like such that the volume resistivity is 10⁶ to 10¹⁶ Ω·cm, and the thickness thereof may be set, for example, at 0.1 mm.

The intermediate transfer belt 14 is entrained with tension around: a drive roll 34 that circulates and drives the intermediate transfer belt 14 by being driven with a motor (not shown in the figures) having excellent constant speed characteristics; a support roll 36 that supports an end portion of a straight line portion of the intermediate transfer belt 14 along the arrangement-direction of the photoreceptors 22; an entrain-tension adding roll (a tension roll) 38 that applies a constant tension to the intermediate transfer belt 14 and prevents meandering of the intermediate transfer belt 14; a support roll 42 that is disposed facing a cleaning unit 40 that scrapes off toner remaining on the intermediate transfer belt 14; and a support roll 16A that is disposed facing a transfer roll (bias roll) 16B configuring the second transfer unit 16. The intermediate transfer belt 14 is entrained with tension by these rolls, and is driven to circulate (rotate) at a predetermined speed in the direction of arrow B.

A voltage of the opposite polarity to charge-polarity of the toner is applied to each of the first transfer rolls 30 that face each of the photoreceptors 22. The toner image of each color on the respective photoreceptor 22 is sequentially electrostatically attracted thereby onto the intermediate transfer belt 14, and a color toner image, of the toner images of the respective colors superimposed on each other, is formed on the intermediate transfer belt 14.

A reference sensor (a home position sensor) 44 is disposed at the upstream side of the image forming unit 12Y in the intermediate transfer belt 14 rotation direction (the arrow B direction). The reference sensor 44 generates a reference signal which acts as a reference for image forming timing in the each of the image forming units 12Y, 12M, 12C, 12K. An image density sensor 46 for adjusting the image quality is disposed at the downstream side of the image forming unit 12K in the intermediate transfer belt 14 rotation direction (the arrow B downstream). The reference sensor 44 identifies a predetermined mark provided on the intermediate transfer belt 14 and generates the reference signal. Each of the image forming units 12 initiates image forming under instruction from the controller 20 based on identification of the reference signal.

A registration roll pair (positional alignment roll pair) 58, configured from a pair of rolls, is provided on the upstream side of the second transfer unit 16 in the transporting direction of the recording paper P. The registration roll pair 58 is rotatable by a motor (not shown in the figures), and rotation and rotation stopping actions are controlled by the controller 20 based on a detection signal of the reference sensor 44.

A transporting belt 64 is provided on the downstream side of the second transfer unit 16 in the transporting direction of the recording paper P, the transporting belt 64 transporting the recording paper P, to which the color toner image has been transferred, to the fixing unit 18. A discharge roll pair 66 is provided on the downstream side of the fixing unit 18 in the recording paper P transporting direction, the discharge roll pair 66 discharging the recording paper P to outside of the printer 10. A discharge tray (discharged paper accommodating unit) 68 is provided outside the printer 10, and the recording paper P discharged by the discharge roll pair 66 is stacked in the discharge tray 68.

The transport device 60 (described in detail later), which transports the recording paper P and reduces (lowers) the burr of the recording paper P, is provided on the paper transporting path 56 at the upstream side of the registration roll pair 58 in the recording paper P transporting direction. The transport device 60 is attached to a mounting portion 62 provided to the frame etc.

A paper reversing path 70 is provided from downstream of the fixing unit 18 in the transporting direction around to upstream in the transporting direction of the transport device 60, with the recording paper P being transported along the paper reversing path 70, by movement of a switching lever (not shown in the figures), so as to reverse the front and back faces of the recording paper P. The paper reversing path 70 includes: plural curved or straight shaped guide plates (not shown in the figures); plural transporting roll pairs 72, that transport the recording paper P, disposed at positions between each of the guide plates; and a switching unit 74 that temporarily stores recording paper P and switches back so that the transporting direction of the recording paper P is switched.

The recording paper P that has completed, by the fixing unit 18, fixing of the image on the front face (one of the faces) is transported to the side of the switching unit 74, and the transporting direction is reversed by the switching unit 74. The recording paper P is subsequently transported in the paper reversing path 70 and the recording paper P is again transported through the transport device 60 and the registration roll pair 58 and image forming is performed to the reverse face (the other of the faces) by the second transfer unit 16. Then after fixing in the fixing unit 18 the recording paper P is discharged by the discharge roll pair 66 and stacked in the discharge tray 68.

Explanation will now be given of the paper feeding device 15.

The paper feeding device 15 is provided in a lower portion of the printer 10. The paper feeding device 15 has paper housing units 50A and 50B that house two types of sheet form recording paper P. Paper feed rolls 52A and 52B are respectively provided at one ends of the paper housing units 50A and 50B and feed out the stored recording paper P with a predetermined timing. The recording paper P fed out by the paper feed rolls 52A or 52B is transported along the paper transporting path 56 configured by plural transporting roll pairs 54 and fed into the second transfer unit 16 (second transfer position) of the image forming section 17.

In the present exemplary embodiment, the paper housing units 50A and 50B are capable of housing recording paper P of different sizes. In the present exemplary embodiment recording paper P of A4 size can be housed in the paper housing unit 50A and recording paper P of B4 size can be housed in the paper housing unit 50B. In the present exemplary embodiment both sizes of recording paper P have their long sides along the transporting direction, so-called longitudinal feed.

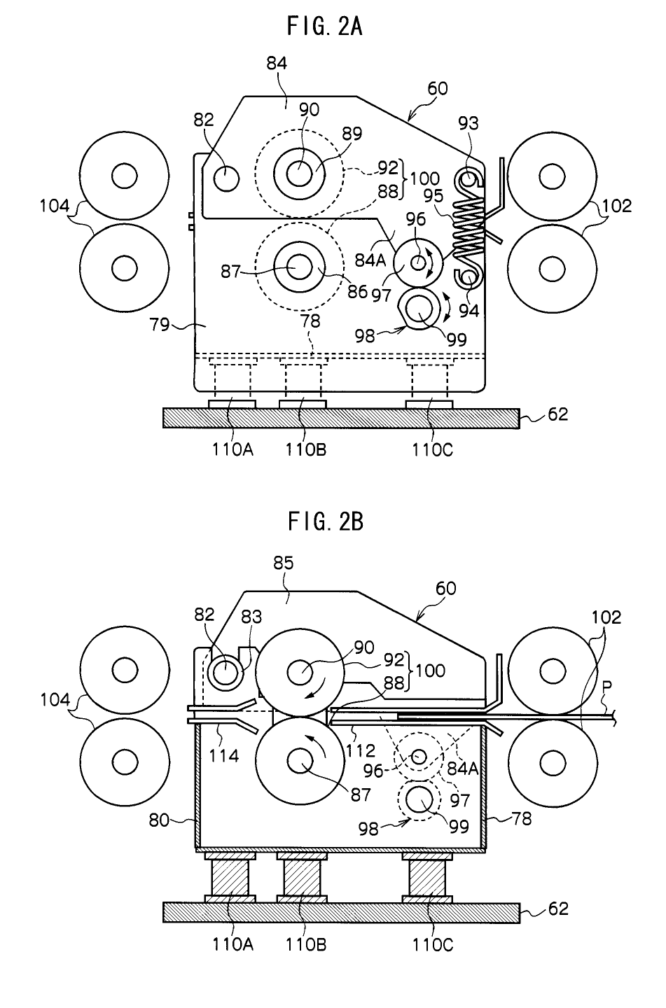

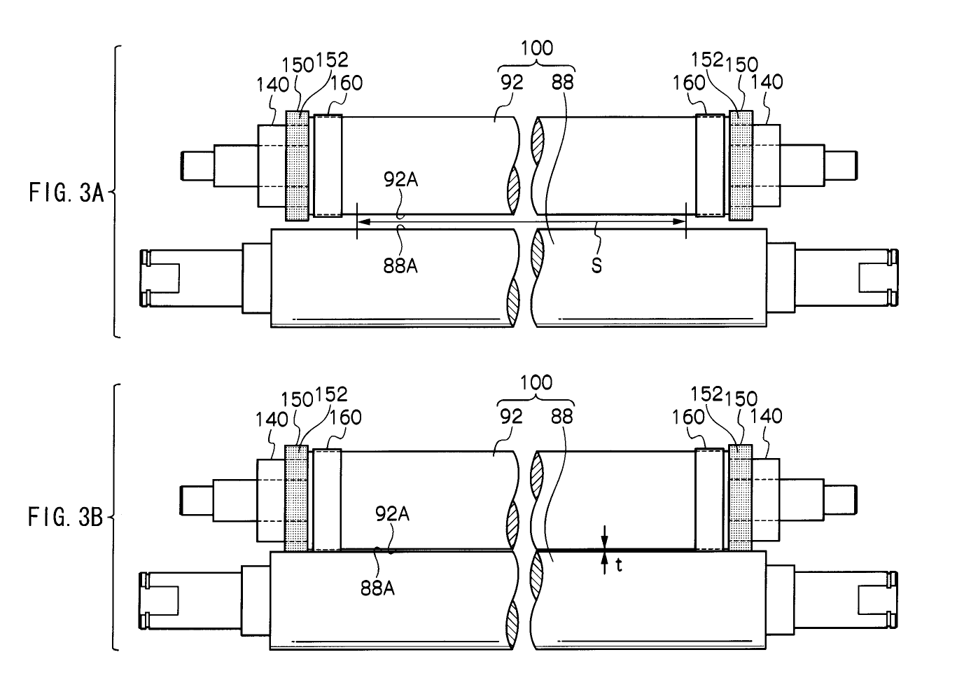

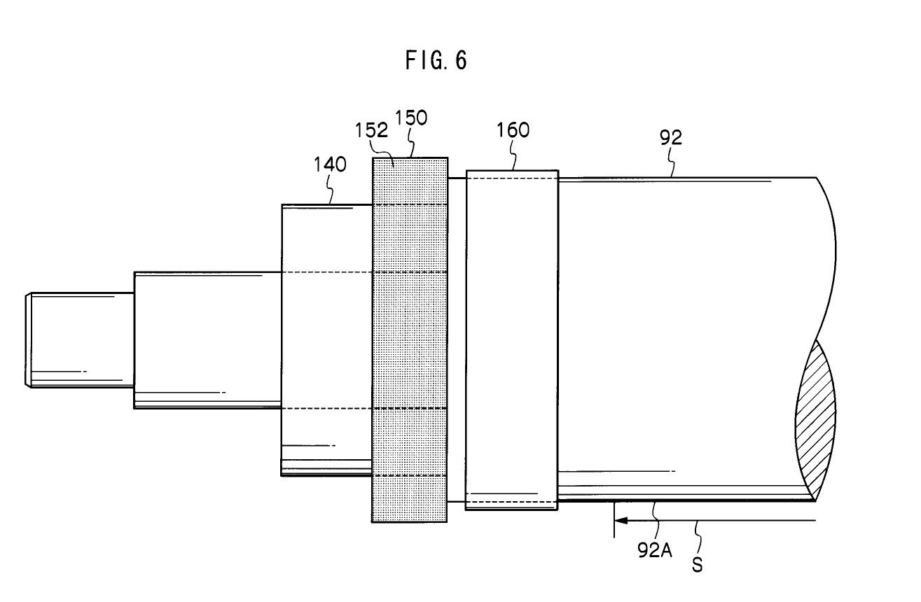

Explanation will now be given of the transport device 60, with reference to FIGS. 2A and 2B, FIGS. 3A and 3B, and FIG. 6. FIG. 2A is a side view showing a transport device according to the exemplary embodiment of the present invention and the vicinity thereof, and FIG. 2B is a vertical cross-section along the transporting direction at a central portion in the width direction. It should be noted that in FIG. 2B, in order to avoid the diagram becoming too complicated and difficult to read, shading to indicate a cross-section has been omitted in some places. FIGS. 3A and 3B show a roll pair of a transport device according to the exemplary embodiment of the present invention, FIG. 3A is a figure showing the roll pair in a separated (away) state, and FIG. 3B is a figure showing the roll pair in an adjacent (near) state. FIG. 6 is an enlargement of one of the axial end portions of the second roll 92 shown in FIGS. 3A and 3B.

As shown in FIG. 2A and FIG. 2B, the transport device 60 includes a main body 78 that has a U-shape in cross-section. Side plates 79 and 80 are provided to the main body 78 at both ends in a width direction, a direction orthogonal to the transporting direction of the recording paper P (a direction coming out from and going into the paper in FIGS. 2A and 2B). A circular pillar shaped support shaft 82 is fixed so as to span across between the side plate 79 and the side plate 80. Arm members 84 and 85, configured from sheet metal, are attached via bearings 83 to the both end portions of the support shaft 82, at the outside of the side plates 79 and 80. The arm members 84 and 85 are thereby capable of swinging relative to the main body 78 about the support shaft 82 as the pivot point.

The transport device 60 is provided with a roll pair 100 configured by a first roll 88 and a second roll 92 disposed so as to face each other. The roll pair 100 presses and squashes the burr at the cut portion of the recording paper P to make it lower (to level it), or in other words, makes the burr lower to reduce it.

Through holes (not shown in the figures) are formed in the side plates 79 and 80 and bearings 86 are fitted into and fixed in these through holes. The first roll 88 of the roll pair 100 is rotatably provided by the both ends of a shaft 87 being inserted into the two bearings 86. One end of the first roll 88 is connected to a motor (not shown in the figures) so as to be rotated in the direction of the arrow by rotation of the motor.

Through holes (not shown in the figures) are also formed in the arm members 84 and 85, and bearings 89 are fitted into an fixed in these through holes. The second roll 92 is rotatably provided by the both ends of a shaft 90 being inserted into the two bearings 89. The second roll 92 follows the rotation of the first roll 88 that is rotated by the motor.

The first roll 88 and the second roll 92 are both configured from a metal material, such as SUS, S45C, SKTM11, or the like, and the outer peripheral faces of the first roll 88 and the second roll 92 are subjected to a surface hardening treatment, such as titanium nitride coating, DLC (diamond-like carbon) coating, hardened chrome plating, or the like. The hardness of the surfaces is a Vickers hardness of 500 Hv or greater. The roll diameters of the first roll 88 and the second roll 92 (the outer diameters in the paper-pass region S where the recording paper P passes) are 35 mm or greater, and the lengths of the rolls are from 350 mm to 360 mm. In the present exemplary embodiment the roll diameters of the first roll 88 and the second roll 92 are the same as each other.

Pins 93 are provided at end portions of the arm members 84 and 85 opposite to the support shaft 82, and the pins 93 project out toward the outside in both directions. Pins 94 projecting out toward the outside in both directions are also provided at the side plates 79 and 80 at positions below the pins 93.

Both end portions of coil springs 95 are attached to the pins 93 and the pins 94 respectively, and a restoring force acts on the arm members 84 and 85. The end portions of the arm members 84, 85 opposite to the support shaft 82 are thereby urged downward, and a pressing force is applied in a direction to make a peripheral face 88A of the first roll 88 and a peripheral face 92A of the second roll 92 approach to each other. In the present exemplary embodiment the first roll 88 and the second roll 92 configuring the roll pair 100 are configured so as to attract each other with a load of 50 kgf.

Substantially triangular shaped projections 84A are formed downwardly at the lower end portions of the arm members 84 and 85 at the side of the pins 93, and pins 96 are provided at the projections 84A, projecting out toward the outside in both directions. Roll followers 97 of a bearing shape are fitted over the outside of the pins 96, and the roll followers 97 are rotatable without coming off from the pins 96 by attachment with an E-ring (not shown in the figures) at each of the end portions of the pins 96.

A shaft 99 is provided via bearings (not shown in the figures) so as to span across between the side plate 79 and the side plate 80, and retract cams 98 are fixed to each of the respective both ends of the shaft 99. The retract cam 98 are thereby made rotatable.

By rotation of the retract cams 98, switching can be made between a separated state in which the second roll 92 (first large diameter portions 150 thereof) is separated from the first roll 88 (see FIG. 2A and FIG. 3A), and an adjacent state in which the second roll 92 is adjacent to the first roll 88 (see FIG. 2B and FIG. 3B). Details of the separated state and the adjacent state are described later.

Upper and lower paper guides 112 are provided on the upstream side of the first roll 88 and the second roll 92 in the recording paper P transporting direction, the paper guides 112 configuring a recording paper P path. In a similar manner, upper and lower paper guides 114 are provided on the downstream side of the first roll 88 and the second roll 92, configuring a path for recording paper P that has passed between the first roll 88 and the second roll 92.

Plural damper members 110 (110A, 110B, 110C) are provided below the bottom face of the main body 78, the damper members 110 being of circular pillar shape and formed from a rubber, such as a urethane rubber or the like.

The damper members 110A to 110C are provided in plural locations (for example in three locations, at portions at the two ends and at a central portion) at intervals therebetween, each along the axial direction of the shaft 87. The damper member 110A and the damper member 110C are set with substantially the same hardness as each other, and the damper member 110B is set with a hardness harder than that of the damper members 110A and 110C. It should be noted that while in the present exemplary embodiment the damper members 110A to 110C are fixed with non-illustrated screws or the like to the top face of the mounting portion 62 and to the bottom of the main body 78, there is no limitation thereto, and fixing may be made, for example, by adhesive or the like.

As shown in FIG. 3A and FIG. 3B, the first large diameter portions 150 and second large diameter portions 160 are provided at the second roll 92 which is the driven roll of the roll pair 100 at the both outsides in the axial direction of the paper-pass region S of the recording paper P.

As shown in FIG. 6, small diameter portions (stepped shaft portions)140 are formed at the axial end portions of the second roll 92, the small diameter portions 140 having a smaller diameter than the outer diameter of the second roll 92 at the paper-pass region S (at the peripheral face 92A). The first large diameter portions 150 are provided at the small diameter portions 140 and have a larger diameter than the outer diameter of the second roll 92 at the paper-pass region S (at the peripheral face 92A). The first large diameter portion 150 is configured from a collar made from metal (not shown in the figures) inserted over the small diameter portion 140, and a resilient layer 152. The resilient layer 152 has a hardness of from 60 Hs (JIS A) to 90 Hs (JIS A) (as per standard JIS K 6301), and in the present exemplary embodiment the resilient layer 152 is configured from a urethane rubber of hardness 90 Hs (JIS A) (as per standard JIS K 6301). The resilient layer 152 is of a thickness of about from 1 mm to 5 mm.

It should be noted that the first large diameter portion 150 may be provided by another method. For example, the first large diameter portions 150 may be formed so as to directly form a resilient layer on the small diameter portion 140.

The second large diameter portions 160 are formed at the inside of the first large diameter portions 150 in the axial direction (and also at the outsides of the paper-pass region S in the axial direction). The second large diameter portion 160 has an outer diameter larger than the outer diameter the second roll 92 at the paper-pass region S (at the peripheral face 92A) and smaller than that of the first large diameter portion 150. In the present exemplary embodiment each second large diameter portion 160 is formed on the peripheral face 92A of the second roll 92 with a urethane resin layer of about 100 μm thickness, having a hardness of 92 Hs (as per standard JIS K 7311). The second large diameter portion 160 may be provided by another method. For example, the second large diameter portion 160 may be formed by adhering tape made from metal or resin to the surface of the second roll 92. Or, the second roll 92 itself may be formed with a larger diameter (stepped). When the second large diameter portion 160 is formed from a resin, the hardness thereof may be greater than 90 Hs (as per standard JIS K 7311) in order to be able to form a gap t, which will be described later, with good precision.

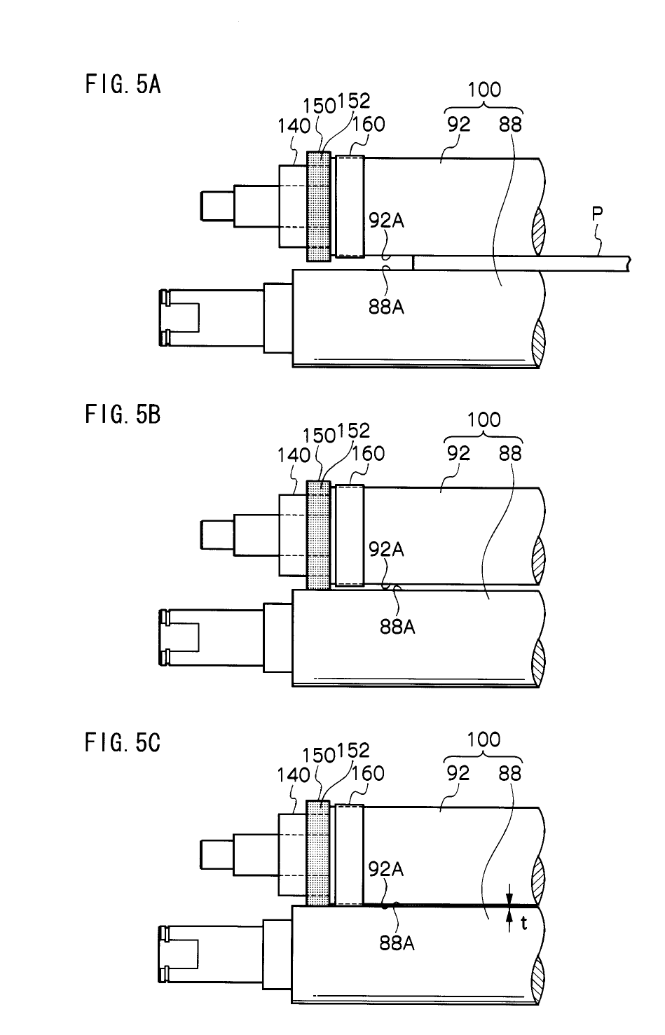

As shown in FIG. 3B, by rotating the retract cams 98 (see FIGS. 2A and 2B) the second roll 92 is made to approach the first roll 88, and the first large diameter portions 150 of the second roll 92 make contact with the peripheral face 88A of the first roll 88 (see also FIG. 5B). Here, the first large diameter portions 150 is elastically deformed (compressed), and as a result, the second large diameter portions 160 also make contact with the peripheral face 88A of the first roll 88, and the gap t is formed between the peripheral face 92A of the second roll 92 and the peripheral face 88A of the first roll 88 (see also FIG. 5C). This state is referred so as the adjacent state, and by rotation of the retract cams 98 from this state (see FIGS. 2A and 2B), the second roll 92 is separated from the first roll 88 and the separated state is achieved, the state in which the first large diameter portions 150 of the second roll 92 are separated from the peripheral face 88A of the first roll 88 and are not elastically deformed.

As shown in FIG. 1 and FIG. 2, a first transporting roll pair 102 is provided very near and on the upstream side of the transport device 60 (the roll pair 100) in the transporting direction, and a second transporting roll pair 104 is provided very near and on the downstream side of the transport device 60 (the roll pair 100). The first transporting roll pair 102 and the second transporting roll pair 104 are disposed so as to be separated from each other in the transporting direction by a shorter distance than the transporting direction length of the recording paper P having the shortest transporting direction length among the recording paper P capable of supply by the paper feeding device 15 (see FIG. 1).

As stated above, in the present exemplary embodiment, the paper feeding device 15 is capable of feeding (supplying) recording paper P of A4 size and B4 size. The first transporting roll pair 102 and the second transporting roll pair 104 are therefore disposed with a separation distance that is shorter than the long side of A4 size recording paper P.

Explanation will now be given of the operation of the present exemplary embodiment.

As shown in FIG. 1, image data output from a non-illustrated image reading device or a personal computer (PC) is input to the printer 10. The printer 10, after subjecting the image data to predetermined image processing in an image processing device (not shown in the figures), forms a color image on the recording paper P under instruction (control) from the controller 20.

In the image processing device, predetermined image processing is performed on the input image data (reflectivity data), such as shading correction, positional alignment correction, lightness/color space conversion, gamma correction, framing deleting, color editing, movement editing, etc. The image data that has been subjected to image processing is converted into color gradation data for four colors, yellow (Y), magenta (M), cyan (C), and black (K), and output to the laser exposure unit 26.

Next, in the laser exposure unit 26, exposing beam emitted from a semiconductor laser according to the input color gradation data is irradiated onto the surfaces of each of the respective photoreceptors 22 that have been charged by the charging rolls 24. Electrostatic latent images are formed on the respective photoreceptors 22 by scanning exposure with the laser exposure units 26. The electrostatic latent images thus formed are formed by the image forming units 12Y, 12M, 12C, 12K into toner images of yellow (Y), magenta (M), cyan (C), and black (K) by the respective developing units 28.

The toner image of each color formed on the respective photoreceptors 22 is transferred in sequence onto the surface of the intermediate transfer belt 14 at the first transfer portions where each of the photoreceptors 22 makes contact with the intermediate transfer belt 14, so as to be superimposed on each other. The color toner image of the superimposed transferred toner images of each color is transported to the second transfer unit 16 along with the rotation of the intermediate transfer belt 14.

In the paper transporting path 56, the recording paper P is fed out from the paper housing unit 50A or the paper housing unit 50B at a timing matched to the image forming by the paper feed roll 52A or paper feed roll 52B. The fed recording paper P is transported by the transporting roll pairs 54 and entered into the transport device 60.

In the transport device 60, in a case where the thickness of the recording paper P is thicker than the gap t, namely, in a case where the thickness the recording paper P is greater than 100 μm, the recording paper P is entered into the transport device 60 with the roll pair 100 in the adjacent state so the roll pair 100 becomes a state as shown in as shown in FIG. 5A. The recording paper P inserted into the transport device 60 is nipped and pressed between the first roll 88 and the second roll 92 configuring the roll pair 100, and transported downstream side in the transporting direction. As this occurs, burr at the edge (the cut portion) of the recording paper P is pressed and squashed to be lowered (leveled) by the pressing force (high pressure) imparted to the recording paper P. In other words, the burr is reduced.

Then, as shown in FIG. 5B, when the trailing edge of the recording paper P has passed between the first roll 88 and the second roll 92, the first large diameter portions 150 of the second roll 92 abut the peripheral face 88A of the first roll 88. When this occurs, the impact force is absorbed by the elastic force of the first large diameter portions 150. The impact noise is thereby suppressed, in comparison to a configuration where the first large diameter portions 150 are not provided.

In the present exemplary embodiment, since the first large diameter portions 150 are provided at the small diameter portions 140, the thickness of the resilient layer 152 can be made thicker, and as a result the impact noise can be effectively suppressed.

Then, as shown in FIG. 1, the recording paper P, which has had its burr leveled lower by the transport device 60, arrives at the registration roll pair 58 and is temporarily stopped. The recording paper P is then transported to the second transfer unit 16 with a timing matched to the movement timing (detected by the reference sensor 44) of the intermediate transfer belt 14 holding thereon the color toner image. The transporting-position of the recording paper P is thereby positionally aligned with the second transfer portion of the color toner image.

In the second transfer unit 16, the color toner image is transferred from the intermediate transfer belt 14 onto the recording paper P. The recording paper P, onto which the color toner image has been transferred, is then separated from the intermediate transfer belt 14 and transported to the transporting belt 64.

The transporting belt 64 transports the recording paper P to the fixing unit 18 in accordance with the optimal transporting speed for the fixing unit 18. The unfixed color toner image on the recording paper P is applied with heat and pressure by being nipped and transported with a fixing roll pair 18A of the fixing unit 18, fixing the color toner image to the recording paper P (fixing processing). The recording paper P with fixed image (color image) formed (fixed) thereon is discharged out of the printer 10 by the discharge roll pair 66 and into the discharge tray 68.

When performing double-sided image forming (on both the front face and the back face), the recording paper P that has completed fixing on the front face is entered into the switching unit 74, the transporting direction is switched, and after transporting along the paper reversing path 70, the recording paper P is entered into the transport device 60. After reducing the burr again, the recording paper P is transported to the registration roll pair 58. Transfer of a color toner image to the back face, fixing is performed in a similar manner, and double-sided image forming is completed.

After the transfer of color toner image onto the recording paper P is completed, toner remaining on the intermediate transfer belt 14 is transported to the cleaning unit 40 along with the rotation of the intermediate transfer belt 14, and removed from the intermediate transfer belt 14.

Other than when performing a printing operation, the retract cams 98 may be rotated to obtain the separated state (see FIG. 2A and FIG. 3A) with the second roll 92 (the first large diameter portions 150) separated from the first roll 88, in the point of view of ease of cleaning of the first roll 88 and the second roll 92 and in the point of view of preventing plastic deformation (permanent deformation) of the first large diameter portions 150 due to constant pressure application thereto.

When performing double-sided printing, since any burr on the recording paper P has already been reduced by the time the recording paper P is re-entered into the transport device 60, the retract cams 98 may be controlled by the controller 20 to move to obtain the separated state, in order to avoid pressure on the image forming face of the recording paper P.

The impact noise, when the first roll 88 and the second roll 92 transition from the separated state (as shown in FIGS. 2A and 3A) to the adjacent state (as seen in FIG. 2B, FIG. 3B) is also suppressed by the first large diameter portions 150 of the second roll 92.

As described above, since the burr in the edge portion of the recording paper P is pressed and squashed down (leveled) by pressing force (high pressure) applied to the recording paper P when passing the roll pair 100, damage, caused by the burr, to members that make contact with the recording paper P at the downstream side of the transport device 60 in the transporting direction (for example, the intermediate transfer belt 14 and the fixing roll pair 18A of the fixing unit 18) is prevented or suppressed.

In a case where the thickness of the recording paper P is less than the gap t, namely when paper equal to or thinner than 100 μm is used, the recording paper P entered to the transport device 60 passes through the gap t without being nipped by the first roll 88 and the second roll 92, namely without being pressed, and is transported toward the downstream side in the transporting direction. In particular, when the second roll 92 and the first roll 88 are configured by hard rolls as described above in a case where the gap t is not provided by the second large diameter portions, such like the present exemplary embodiment, since warping (deflection) occurs in the second roll 92 and the first roll 88 at the axial direction central portions so as to apart (float) from each other, force acts, toward the axial direction center, on the recording paper nipped by the second roll 92 and the first roll 88. By forming the gap t such that thin paper without much stiffness is able to pass by the second large diameter portions 160, generation of creases, due to force acting on the recording paper P toward the axial direction center, is either prevented or suppressed.

Generally for thin recording paper P that is 100 μm or less in thickness, there is no burr, or the burr is significantly less in comparison to recording paper P that is thicker than 100 μm, and even if there is a burr then it is generally less stiffness in burr in comparison to recording paper P of 100 μm thickness.

Consequently, with such thin recording paper P, even if pressed by the roll pair 100, damage does not so readily occur on members contacted by the recording paper P on the downstream side of the transport device 60 in the transporting direction (for example the intermediate transfer belt 14, the fixing roll pair 18A of the fixing unit 18), in comparison to recording paper P of thicker than 100 μm.

The first transporting roll pair 102 and the second transporting roll pair 104 are disposed with a separation shorter than the long side length of A4 recording paper P (longitudinal length). Therefore, even when such recording paper P of 100 μm or less is not nipped by the roll pair 100, the recording paper P is smoothly transported to the transporting direction downstream side.

It should be noted that the thickness taken for recording medium not requiring burr reduction is set at 100 μm or less in the present exemplary embodiment, but this thickness may be set as appropriate, and the size of the gap t set according to this thickness.

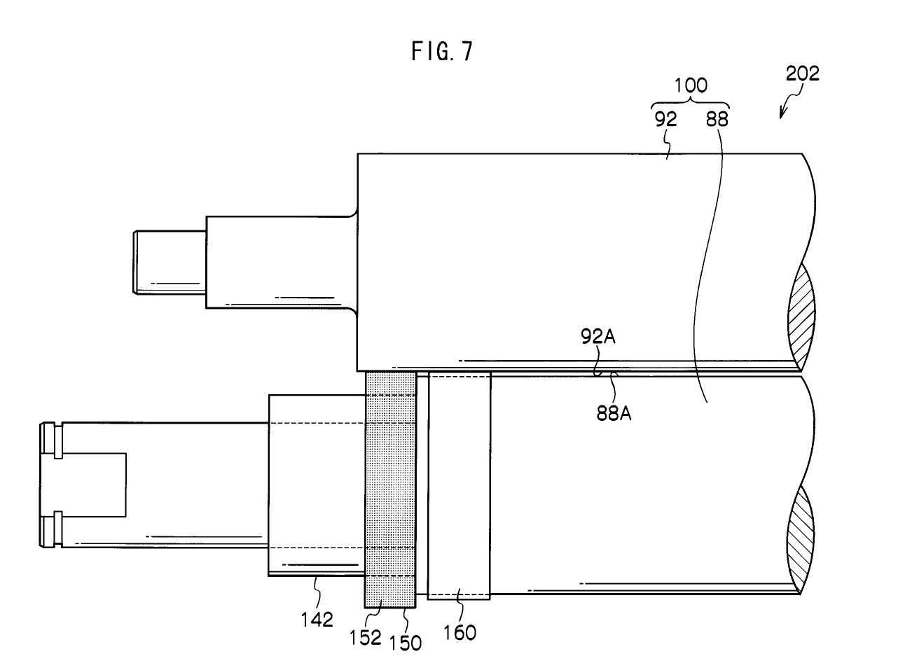

Explanation will next be given of a modified example of a transport device of the present exemplary embodiment. Only one end portion in the axial direction is shown in FIG. 7 to FIG. 13, there is provided a similar configuration, except for being left-right symmetric for the other end portion.

In a transport device 202 of a first exemplary modification, as shown in FIG. 7, a small diameter portion 142 is formed at an end portion in the axial direction of the first roll 88, and the first large diameter portion 150 is disposed at the small diameter portion 142. The second large diameter portion 160 is provided at the axial direction inside of the first large diameter portion 150 of the first roll 88. In other words, the first large diameter portions 150 and the second large diameter portions 160, both having a diameter larger than that of the outer diameter, at the recording paper P paper-pass region S, of the first roll 88 (the peripheral face 88A), are provided at the first roll 88 as the driving side.

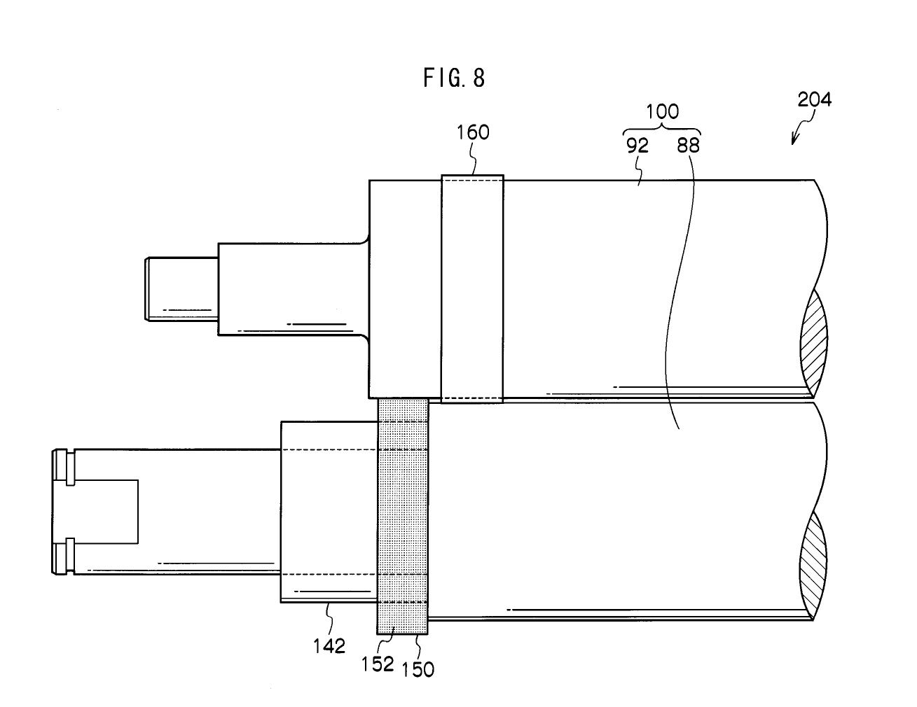

In a transport device 204 of a second exemplary modification, as shown in FIG. 8, the small diameter portion 142 is formed at an end portion in the axial direction of the first roll 88, and the first large diameter portion 150 is disposed at the small diameter portion 142. The second large diameter portion 160 is provided at the second roll 92. The first large diameter portion 150 and the second large diameter portion 160 are provided in different positions in the axial direction.

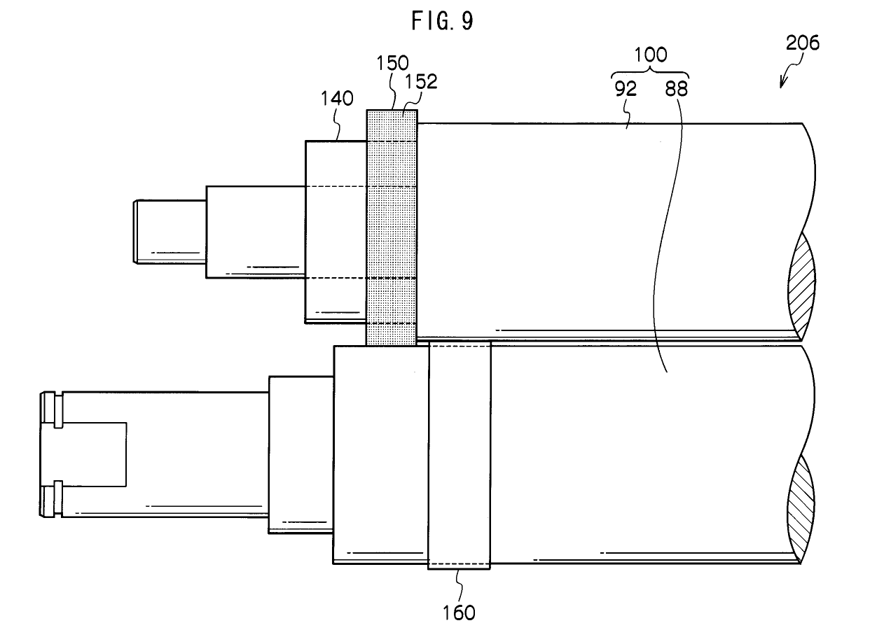

A transport device 206 of a third exemplary modification, as shown in FIG. 9, is provided with the first large diameter portion 150 disposed at the small diameter portion 140 of the second roll 92. The second large diameter portion 160 is provided at the first roll 88. The first large diameter portion 150 and the second large diameter portion 160 are provided in different positions in the axial direction.

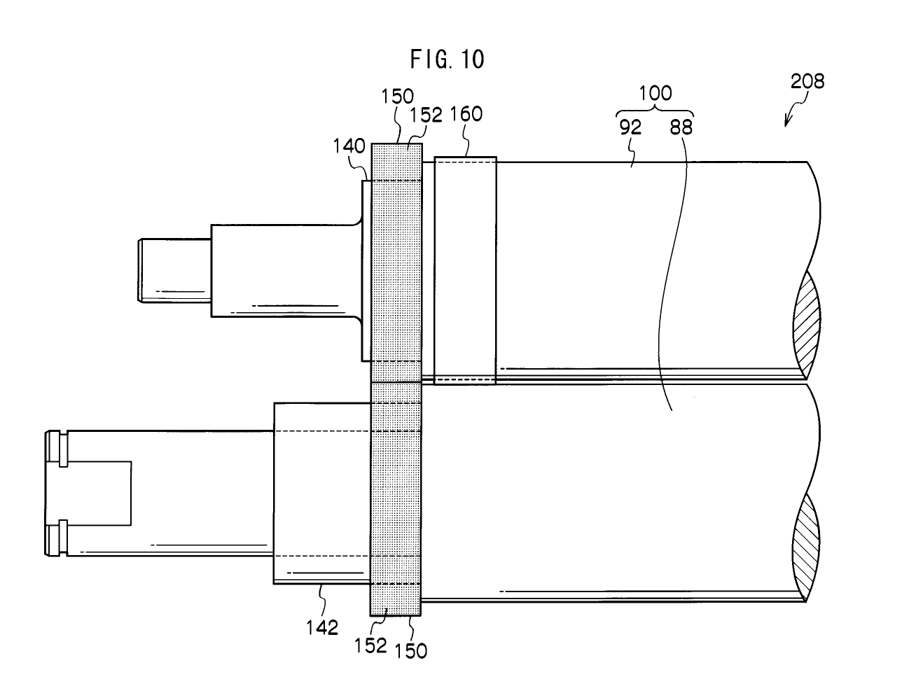

A transport device 208 of a fourth exemplary modification, as shown in FIG. 10, is provided with the first large diameter portion 150 disposed at the small diameter portion 140 of the second roll 92, and with the second large diameter portion 160 disposed at the axial direction inside of the first large diameter portion 150 of the second roll 92. The first large diameter portion 150 is also provided at the small diameter portion 142 of the first roll 88. The first large diameter portion 150 of the first roll 88 and the first large diameter portion 150 of the second roll 92 are provide so as to make contact with each other.

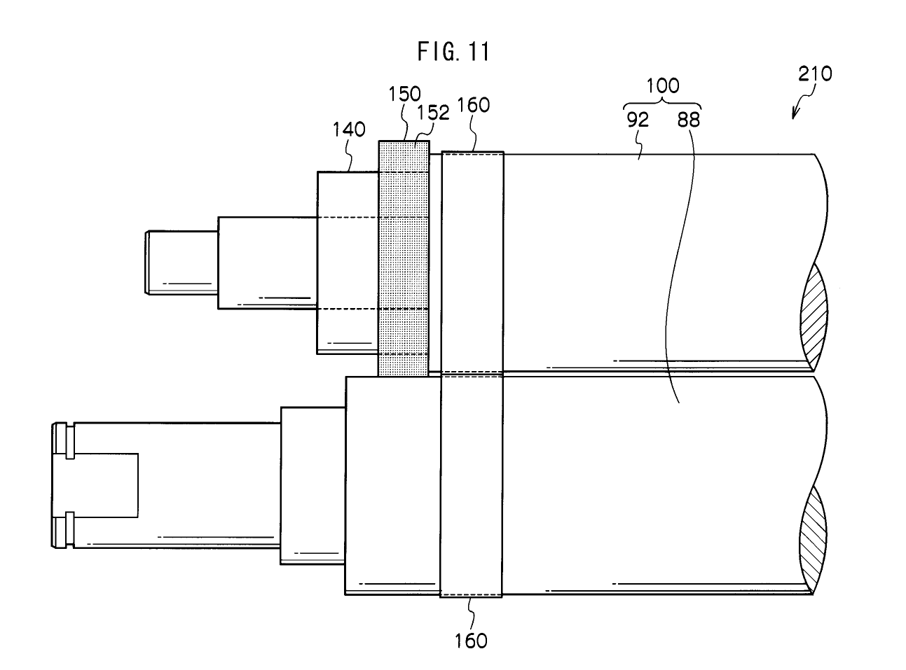

A transport device 210 of a fifth exemplary modification, as shown in FIG. 11, is provided with the first large diameter portion 150 disposed at the small diameter portion 140 of the second roll 92, and with the second large diameter portion 160 provided at the axial direction inside of the first large diameter portion 150 of the second roll 92. The second large diameter portion 160 is also provided at the first roll 88. The second large diameter portion 160 of the first roll 88 and the second large diameter portion 160 of the second roll 92 are provided so as to make contact with each other.

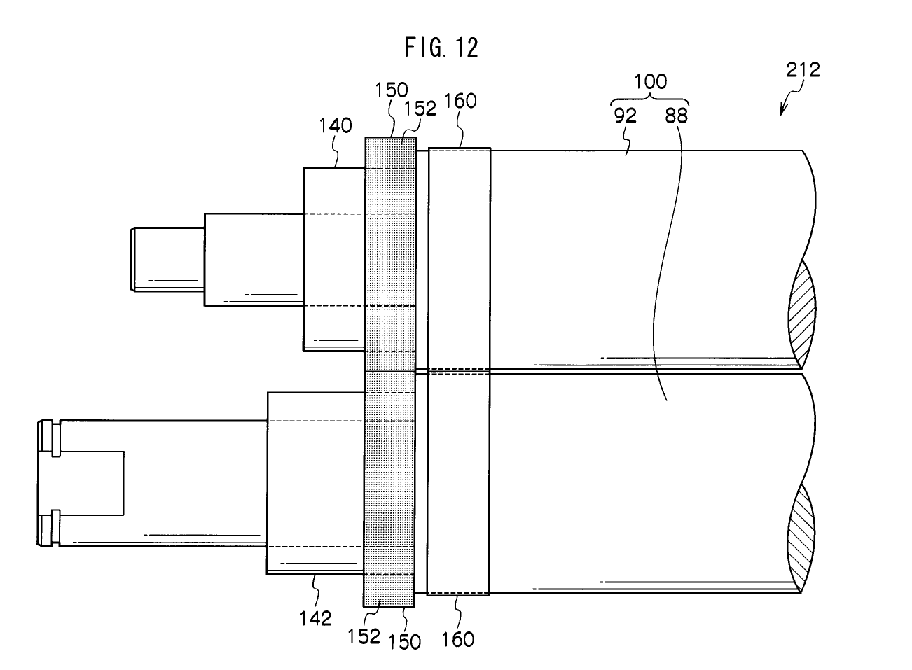

A transport device 212 of a sixth exemplary modification, as shown in FIG. 12, is provided with the first large diameter portion 150 disposed at the small diameter portion 140 of the second roll 92, and with the second large diameter portion 160 provided at the axial direction inside of the first large diameter portion 150 of the second roll 92. The first large diameter portion 150 is also provided at the small diameter portion 142 of the first roll 88, and the second large diameter portion 160 is provided at the axial direction inside of the first large diameter portion 150 of the first roll 88. The first large diameter portions 150 of the first roll 88 and the second roll 92, and the second large diameter portions 160 of the first roll 88 and the second roll 92 are provided so as to make respective contact with each other.

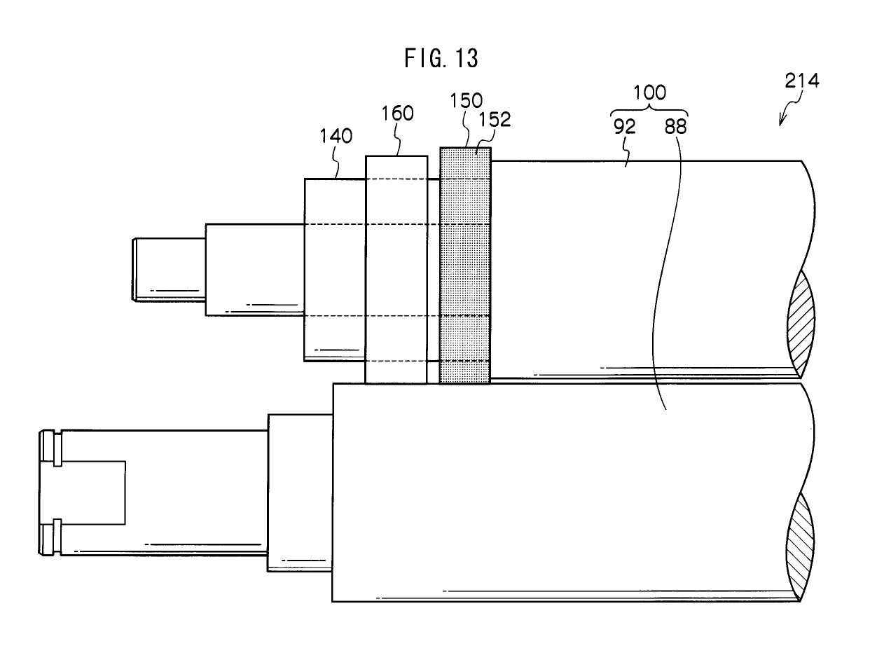

It should be noted that while in each of the transport device 60 (see FIG. 3) and the first modified transport device 202 to the sixth modified transport device 212 of the present exemplary embodiment, the first large diameter portions 150 are disposed at the axial direction outside and the second large diameter portions 160 are disposed at the axial direction inside, there is no limitation thereto. As represented by a transport device 214 of a seventh exemplary modification, as shown in FIG. 13, the first large diameter portions 150 may be disposed at the axial direction inside, and the second large diameter portions 160 may be disposed at the axial direction outside.

It should be noted that the present invention is not limited to the exemplary embodiments given above.

For example, in the above exemplary embodiment, the first transporting roll pair 102 and the second transporting roll pair 104 are provided, respectively, at the transporting direction upstream side and the transporting direction downstream side of the transport device 60, however there is no limitation thereto. One of the first transporting roll pair 102 and the second transporting roll pair 104, or both of the first transporting roll pair 102 and the second transporting roll pair 104 may be provided within the transport device.

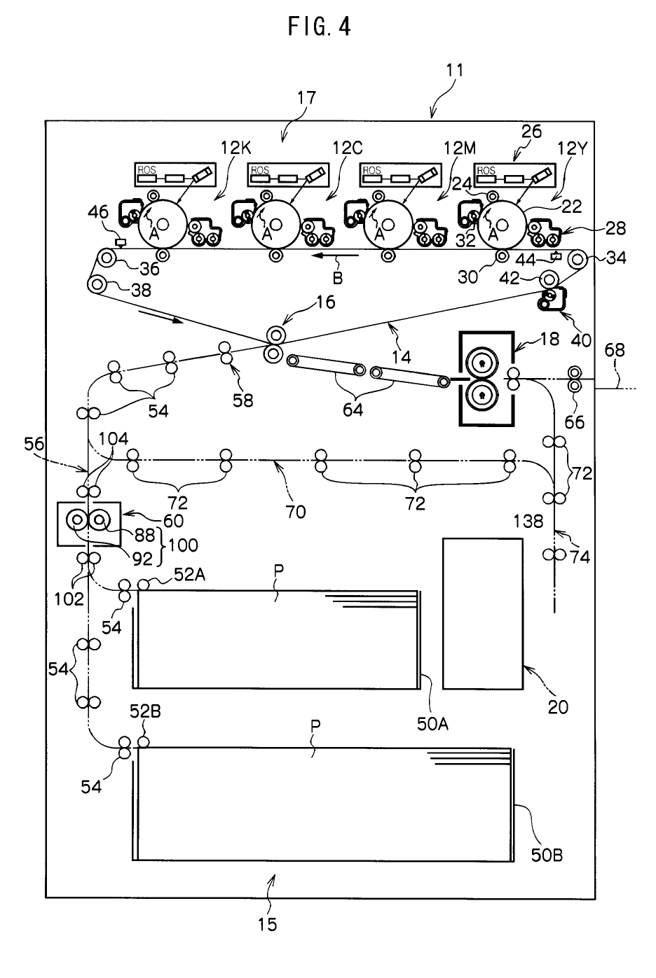

Also, for example, in the above exemplary embodiment, as shown in FIG. 1, the transport device 60 is disposed near the registration roll pair 58 at the transporting direction upstream side, however there is no limitation thereto. For example, as in the example of another printer 11 shown in FIG. 4, the transport device may be disposed in a position closer to the paper feeding device 15 than in the printer 10 of the present exemplary embodiment. In such a case, recording paper P which passes once through the transport device 60 does not pass through the transport device 60 again after fixing has been completed of the front face in a case of the double-sided image forming. Therefore, control to separate the second roll 92 from the first roll 88 during double-sided image forming, in order that pressing force (high pressure) is not applied to the image forming face of the recording paper P, becomes unnecessary (control does not become complicated).

Also, for example, recording paper (cut paper) P that had already been cut and is in a sheet form is housed in the paper feeding device 15 of the above exemplary embodiment, and fed out therefrom, however there is no limitation thereto. Other recording medium in a sheet form other than recording paper may be used, for example, OHP sheets etc. A feeder device may also be used that accommodates roll paper, cuts the roll paper, and feeds out recording paper in sheet form.

Also, for example, in the above exemplary embodiment, images are formed in the image forming section 17 using an electrophotographic method, however there is no limitation thereto. Other image forming method may be used, such as an inkjet method, a thermal transfer method, a printing plate method or the like.

In the above exemplary embodiment, the second roll 92 is moved by the retract cams 98, the roll followers 97, the arm members 84 and 85, the support shaft 82 and the like, however there is no limitation thereto. The second roll 92 may be moved by another mechanism or member, for example, by a solenoid, linear slider or the like.

In the above exemplary embodiment the second roll 92 is configured to move, however there is no limitation thereto. The first roll 88 may be configured to move. Or the second roll 92 and the first roll 88 may both be configured to move.

In the above exemplary embodiment the pressing mechanism used for pressing the second roll 92 and the first roll 88 in the direction to make them approach each other is the arm members 84 and 85 and the coil springs 95 etc., however there is no limitation thereto. Other configurations and members may be used for pressing the second roll 92 and the first roll 88 in the direction to make them approach each other.

What is claimed is:

1. A recording medium transport device comprising:
a rotating body pair that includes a pair of rotating bodies disposed on a transport path of a recording medium;
a pressing mechanism that presses the rotating bodies in a direction such that the rotating bodies approach each other;
first large diameter portions that are elastically deformable and are provided at both axial direction outer sides of a region where the recording medium passes of at least one of the rotating bodies, the first large diameter portions having a larger diameter than the outer diameter at the region; and
second large diameter portions that are provided at both axial direction outer sides of the region of at least one of the rotating bodies of the rotating body pair, the second large diameter portions having a larger diameter than the outer diameter at the region and having a smaller diameter than the first large diameter portions, and the second large diameter portions forming a gap between peripheral faces of the rotating bodies at the region in a state where the first large diameter portions are elastically deformed.

2. The recording medium transport device of claim 1, wherein:
small diameter portions are formed at both the axial direction outer sides of the region of at least one of the rotating bodies, the small diameter portions having a smaller diameter than the outer diameter at the region; and
the first large diameter portions are formed by layers of elastic material capable of elastic deformation at the small diameter portions.

3. The recording medium transport device of claim 1, further comprising an approach-separation switching unit that switches between:
an adjacent state in which the rotating bodies are adjacent to each other, and the second large diameter portions form the gap between the peripheral faces of the rotating bodies at the region in the state where the first large diameter portions are elastically deformed; and
a separated state in which the rotating bodies are moved away from each other from the adjacent state, and the first large diameter portions are not elastically deformed.

4. The recording medium transport device of claim 2, further comprising an approach-separation switching unit that switches between:
an adjacent state in which the rotating bodies are adjacent to each other, and the second large diameter portions form the gap between the peripheral faces of the rotating bodies at the region in the state where the first large diameter portions are elastically deformed; and
a separated state in which the rotating bodies are moved away from each other from the adjacent state, and the first large diameter portions are not elastically deformed.

5. The recording medium transport device of claim 1, wherein, at each of the both axial direction outer sides of the region, the first large diameter portion and the second large diameter portion are provided at different positions in the axial direction.

6. The recording medium transport device of claim 1, wherein the gap is formed by the second large diameter portions provided at one of the rotating bodies contacting the other of the rotating bodies in a state where the first large diameter portions are elastically compression-deformed.

7. The recording medium transporting device of claim 1, wherein the gap is formed by the second large diameter portions provided at one of the rotating bodies contacting the second large diameter portions provided at the other of the rotating bodies in a state where the first large diameter portions are elastically compression-deformed.

8. The recording medium transport device of claim 1, wherein the first large diameter portions are provided at only one of the rotating bodies.

9. The recording medium transport device of claim 1, wherein the first large diameter portions are provided at both of the rotating bodies.

10. The recording medium transport device of claim 1, wherein the second large diameter portions are provided at only one of the rotating bodies.

11. The recording medium transport device of claim 1, wherein the second large diameter portions are provided at both of the rotating bodies.

12. An image forming apparatus comprising:
a recording medium feed unit that feeds a recording medium;
an image forming unit that forms an image on the recording medium fed from the recording medium feed unit; and
a recording medium transport device provided on a transporting path of the recording medium between the recording medium feed unit and the image forming unit, the recording medium transport device including:
a rotating body pair that includes a pair of rotating bodies disposed on the transporting path of the recording medium;
a pressing mechanism that presses the rotating bodies in a direction such that the rotating bodies approach each other;
first large diameter portions that are elastically deformable and are provided at both axial direction outer sides of a region where the recording medium passes of at least one of the rotating bodies, the first large diameter portions having a larger diameter than the outer diameter at the region; and
second large diameter portions that are provided at both axial direction outer sides of the region of at least one of the rotating bodies of the rotating body pair, the second large diameter portions having a larger diameter than the outer diameter at the region and having a smaller diameter than the first large diameter portions, and the second large diameter portions forming a gap between peripheral faces of the rotating bodies at the region in a state where the first large diameter portions are elastically deformed.

13. An image forming apparatus comprising:
a recording medium feed unit that feeds a recording medium;
an image forming unit that forms an image on the recording medium fed from the recording medium feed unit; and
a recording medium transport device provided on a transporting path of the recording medium between the recording medium feed unit and the image forming unit, the recording medium transporting device including:
a rotating body pair that includes a pair of rotating bodies disposed on the transporting path of the recording medium;
a pressing mechanism that presses the rotating bodies in a direction such that the rotating bodies approach each other;
first large diameter portions that are elastically deformable and are provided at both axial direction outer sides of a region where the recording medium passes of at least one of the rotating bodies, the first large diameter portions having a larger diameter than the outer diameter at the region;
second large diameter portions that are provided at both axial direction outer sides of the region of at least one of the rotating bodies of the rotating body pair, the second large diameter portions having a larger diameter than the outer diameter at the region and having a smaller diameter than the first large diameter portions, and the second large diameter portions forming a gap between peripheral faces of the rotating bodies at the region in a state where the first large diameter portions are elastically deformed; and
an approach-separation switching unit that switches between: an adjacent state in which the rotating bodies are adjacent to each other, and the second large diameter portions form the gap between the peripheral faces of the rotating bodies at the region in the state where the first large diameter portions are elastically deformed; and a separated state in which the rotating bodies are moved away from each other from the adjacent state, and the first large diameter portions are not elastically deformed,
when the recording medium, having pressed through the recording medium transporting device and had an image formed on one face, passes through the recording medium transporting device again to form an image on the other face of the recording medium, the rotating bodies being in the separated state where the rotating bodies are separated when the recording medium on which the image has been formed on the one face passes through the recording medium transporting device again.

14. The image forming apparatus of claim 12, wherein a distance in the transporting direction between a first transporting roll pair, that is provided near the rotating body pair at the transporting direction upstream side and transports the recording medium toward the downstream side, and a second transporting roll pair, that is provided near the rotating body pair at the transporting direction downstream side and transports the recording medium toward the downstream side, is set at a length that is shorter than a transporting direction length of a recording medium having the shortest transporting direction length among the recording media capable of being fed by the recording medium feed unit.

15. The image forming apparatus of claim 13, wherein a distance in the transporting direction between a first transporting roll pair, that is provided near the rotating body pair at a transporting direction upstream side and transports the recording medium toward a downstream side, and a second transporting roll pair, that is provided near the rotating body pair at the transporting direction downstream side and transports the recording medium toward the downstream side, is set at a length that is shorter than a transporting direction length of a recording medium having the shortest transporting direction length among recording media capable of being fed by the recording medium feed unit.
